(19) United States
(12) Patent Application Publication
(10) Pub. No.: US 2004/0171763 A1
(43) Pub. Date: Sep. 2, 2004

(54) Hot-melt adhesive composition and process for the preparation of a textile product

(76) Inventors: Albert Arnold Van Geenen, Sittard (NL); Cornelis Eme Koning, Brunssum (NL); Remko H. Vreekamp, Maastricht (NL); Mathijs Hubert Gertrudes Maassen, Stein (NL)

Correspondence Address: Pillsbury Winthrop, 1600 Tyson Boulevard, McLean, VA, 22102, US

(21) Appl. No.: 10/475,808

(22) PCT Filed: Apr. 24, 2002
(86) PCT No.: PCT/NL02/00274

(30) Foreign Application Priority Data
Apr. 25, 2001 (NL) 1017941

(51) Int. Cl. C08G 69/26; C08L 63/00

(52) U.S. Cl. 525/423; 528/332

(57) ABSTRACT

The invention relates to a hot-melt adhesive composition for use in a textile product, in particular a tufted carpet, containing a polymer chosen from the group of polyamides, with a number-average molecular mass of 500-5000 g/mol and functional end groups. This hot-melt adhesive composition can be applied in various forms and results in a good bond of pile material to support material. The invention also relates to a process for the preparation of a textile product, in which the hot-melt adhesive composition is used, and also to the textile product thus obtained and the use thereof as floor or wall covering.

The invention relates to a hot-melt adhesive composition for use in a textile product, in particular a tufted carpet, containing a polymer chosen from the group of polyamides. The invention also relates to a process for the preparation of a textile product, a textile product obtainable by this process, in particular a tufted carpet, and the use thereof as floor or wall covering.

Such a hot-melt adhesive is known from patent application WO-A-9312285. Said publication also describes a recyclable tufted carpet in which such a hot-melt adhesive composition is used, and a process for the preparation of such a carpet.

In a generally used process for the preparation of a tufted carpet first a fibrous pile material, for instance an optionally twined yarn or a yarn bundle consisting of filaments or staple fibre, is inserted into a support by ‘tufting’, as a result of which the pile material projects on the front side of the support and the pile material forms a loop at the back. As fibrous pile material use can for instance be made of polyesters, polyamides, polyolefins or other natural or synthetic materials and combinations of these. Besides tufting other techniques can also be employed to form piles on a support, for instance by weaving. The support may for instance be a fleece or a fabric prepared from a material of natural and/or synthetic origin and provides the carpet with mechanical strength and dimensional stability. If desired, the tuft or pile formed can be cut, for instance for velour-type materials. After an optional paint or print treatment, the tufted support is in following steps provided with one or more adhesives and optionally a second backing. An adhesive is used in particular to bond the pile material to the support so as to obtain a good tuft withdrawal force (good bonding/anchoring of the yarn or the fibre bundle to the first support) and a good pilling resistance (good mutual adhesion of the fibres in the yarn or the fibre bundle). As adhesive usually a styrene butadiene latex (SBR) is used. However, the use of these SBR latices does involve various drawbacks, both from a production and from an environmental point of view. In the last few years, therefore, various alternative adhesives have been developed, usually containing a thermoplastic polymer, which can be applied in melted condition or in solid form, for instance as a powder, film or fibre, and are subsequently melted. Such an adhesive is also referred to as a hot-melt adhesive:

WO-A-9312285 describes the use of a hot-melt adhesive in a recyclable carpet, in which carpet the polymers in the various components, the first support, the fibrous pile material, the backing material and the adhesive, all belong to the same group of polymers, and preferably are a polyamide, a polyester, or a polypropylene. The tufted pile material is bonded to the first support using a hot-melt adhesive composition as adhesive, which is applied in the form of a paste and subsequently melted. This hot-melt adhesive composition contains a copolymer having a melting point of 100-170° C.

A drawback of the hot-melt adhesive composition from WO-A-9312285 is that, for adequate bonding of the pile material fibres to the first support, it can only be applied in the form of a paste, with dispersed, very fine particles of copolymer, with a particle size smaller than 100 μm. The preparation of such a fine copolymer powder is a technically complicated and expensive process as the heat of friction generated may cause the copolymer to melt. An additional drawback is that, to ensure that adequate bonding is achieved during melting of the copolymer, pressure must usually be applied to the tufted support with the hot-melt adhesive composition, in particular to improve the pilling resistance. If the hot-melt adhesive composition is applied in solid form, for instance as a powder, a film or a fibre, the desired bonding is not achieved. Another drawback is that a relatively large amount of hot-melt adhesive composition is to be applied.

The object of the invention therefore is to provide a hot-melt adhesive composition that does not have the aforementioned drawbacks or that has these drawbacks to a substantially lesser extent.

Surprisingly, this object is achieved according to the invention in that the hot-melt adhesive composition contains a polymer with a number-average molecular mass of 500-5000 g/mol and functional end groups.

Molecular mass is here understood to be the number-average molecular mass (Mₙ), unless indicated otherwise.

It is surprising that said hot-melt adhesive composition should result in a textile product with good properties, for a polymer with such a low molecular mass generally exhibits inferior mechanical properties. It has been found that a textile product, in particular a tufted carpet, in which a hot-melt adhesive composition according to the invention is used, has a tuft withdrawal force that meets the industrial requirements (for instance according to ASTM D13356-72), and a good pilling resistance.

Another major advantage of the hot-melt adhesive composition according to the invention is that the hot-melt adhesive composition cannot only be applied in solid form, for instance as a powder, but also as a water-borne paste or as a suspension or emulsion, without the particle size being really critical. In both cases use can be made, optionally after minor modifications, of existing production equipment for the preparation of textile products such as tufted carpets.

Preferably the molecular mass of the polymer in the hot-melt adhesive composition is at least 1000 g/mol, since this results in better withdrawal properties. The polymer in the hot-melt adhesive composition preferably has a molecular mass lower than 4000 g/mol. The advantage of this is a higher pilling resistance of the textile product. It has been found that when the molecular mass is at least 1000 g/mol no undesirable stiffening of the piles or tufts takes place while good bonding is achieved.

The melt viscosity of the polymer in the hot-melt adhesive composition, as for instance measured using a capillary viscometer at 180° C., therefore preferably is about 1-200 Pa.s, more preferably about 2-100 Pa.s, and most preferably about 5-50 Pa.s. If desired, the melt viscosity can also be determined at a different temperature, depending on the polymer's melting point.

From WO-A-9632528 a reactive composition containing a polymerizable monomer is known, which composition has a very low viscosity and can be used as an adhesive for making a tufted carpet having the desired properties, but a major drawback of said reactive composition is that the required polymerization reaction is highly sensitive to even traces of water, for instance water that is generally present in the tufted pile material, as a result of which the polymerization reaction is very difficult to control. In addition, substantial adaptations of existing carpet manufacturing equipment prove necessary to be able to use this reactive composition as an adhesive.

In the context of the present patent application functional end groups are understood to be

a) reactive groups capable of reacting with the polymer in the hot-melt adhesive composition, or with bi- or polyfunctional chain extension or crosslinking agents; suitable examples of reactive groups include carboxylic acid, carboxylic anhydride, hydroxy and amine groups; and/or

b) non-reactive groups, such as for instance aliphatic, cycloaliphatic and aromatic compounds with 1-40 C atoms and optionally one or more heteroatoms.

Depending on their character, these functional end groups for instance serve to control the molecular mass of the polymer, for instance non-reactive groups to limit the molecular mass; to change the melting point of the polymer; to influence the polarity of the polymer, and thus for instance the compatibility with pile and backing material, or the water- or dirt-repellent properties; to control mechanical or electrical properties; or to be able to increase the molecular mass of the polymer at a later stage by reaction with a chain extender or crosslinking agent.

Such functional end groups may have been incorporated in the polymer during the polymerization reaction, for instance by using a suitable compound with one or more reactive groups as comonomer, but also by allowing a polymer to react with such a compound at a later stage.

As functional end groups the polymer may contain only reactive groups or only non-reactive groups, but also a combination of both. The advantage of reactive groups is a possibility of later reaction with a chain extender or crosslinking agent, while the advantage of non-reactive groups is a high stability of the polymer in melted condition. These properties of the hot-melt adhesive composition can be controlled by choosing a polymer with a combination of reactive and non-reactive groups. Preferably the polymer contains at least two reactive groups as functional end groups. Preferably, these reactive groups are carboxylic acid groups. This has the advantage that a polymer is obtained which, on the one hand, under suitable conditions, for instance in a melted condition, has a high reactivity with respect to known chain extenders and/or crosslinking agents but, on the other hand, under normal storage conditions, or without the presence of chain extenders and/or crosslinking agents, results in a hot-melt adhesive composition with virtually constant viscosity.

The polymer in the hot-melt adhesive composition according to the invention is chosen from the group of polyamides. In principle any thermoplastic polyamide can be used.

Examples of suitable polyamides are polycondensates derived from an aliphatic diamine and an aliphatic and/or aromatic dicarboxylic acid, or a derivative thereof, or polycondensates derived from an α,ω-aminocarboxylic acid, in particular a lactam derived therefrom, or polycondensates derived from mixtures of said compounds. Suitable diamines can be described by the general formula H₂N—R—NH₂, where R is a linear or branched (cyclo)aliphatic radical with 2-24 C atoms and optionally one or more heteroatoms, such as N, O or S atoms. Preferably use is made of ethylene diamine, butylene diamine, hexamethylene diamine, 2-methylpentamethylene diamine, or piperazine. As dicarboxylic acid, compounds of the general formula HOOC—R¹—COOH can be used, where R is a linear or branched (cyclo)aliphatic or aromatic radical with 2-40 C atoms and optionally one or more heteroatoms, such as N, O or S atoms. Preferably, use is made of adipic acid, azelaic acid, dimeric fatty acid, dodecane dicarboxylic acid or isophthalic acid. As α,ω-aminocarboxylic acid or lactam preferably compounds with 6-12 C atoms are chosen.

The polyamide in the hot-melt adhesive composition according to the invention may also contain a minor amount of a monomer derived from a compound with three of more carboxylic acid or amine groups. As a result, branched rather than linear polymer chains are obtained. The advantage of such a branched polyamide is that a hot-melt adhesive composition with this polymer has a low viscosity, but after application of the hot-melt adhesive the branched polymer readily reacts with a chain extender or crosslinking agent to form a polymer with higher molecular mass and with improved mechanical properties. Most preferably a polyamide is chosen that is substantially composed of ε-caprolactam as monomer. The polyamide preferably has an ε-caprolactam content of at least 40 mol %, more preferably at least 50 mol %. This is advantageous in particular for use in a textile product in which a polyamide 6 pile material is used.

The polymer in the hot-melt adhesive composition according to the invention may be semi-crystalline and have a melting point, but it may also be virtually amorphous and so have only a glass transition point. If the polymer has a melting point, this melting point is preferably lower that that of the components to be bonded, so that the hot-melt adhesive composition in the melted condition can wet and/or penetrate these components without damaging them, and after cooling a good bond is obtained. For this reason the polymer preferably has a melting point that is at least about 20° C. lower, more preferably at least about 30° C. lower, and most preferably at least about 40° C. lower than that of the components to be bonded.

If the polymer has only a glass transition point, the polymer in the hot-melt adhesive composition preferably has a glass transition point at such a temperature that the polymer has such a low viscosity at the temperature to which the hot-melt adhesive composition is heated upon application that it can wet and/or penetrate the components to be bonded and a good bond is obtained upon cooling. In the context of the present patent application this temperature is called softening point, and in general it is more than 50° C. higher than the glass transition point. An amorphous polymer generally has a glass transition point between 50 and 90° C. In the following, melting point is also understood to be the softening point.

It is known to one skilled in the art that the melting point or the glass transition point of a polymer can be lowered by preparing copolymers. For polyamide copolymers the effect of amount and type of comonomer on the melting point is for instance described in ‘Nylon Plastics Handbook’, M. I. Kahn (Ed.), Hauser Verlag, Munich 1995 (ISBN 3-446-17048-0), chapters 9 and 11. In ‘Encyclopaedia of polymer science and engineering’, Volume 12, John Wiley & Sons, New York 1988 (ISBN 0-471-80944-6), pages 1-75 and 217-256, melting points of different copolyesters are described. In general, copolymers in which comonomers are randomly incorporated in the polymer chain, for instance during a polycondensation reaction, exhibit a greater decrease in melting point than copolymers of a block copolymer nature.

It has now been found that in the polymer in the hot-melt adhesive composition according to the invention with low molecular mass also comonomers that are only terminally present already have a sufficiently high melting-point-lowering effect. These terminal comonomers are in the above referred to as functional end groups.

In a textile product, in particular a tufted carpet, use is often made of synthetic fibres on the basis of a polyester, in particular polyethylene terephthalate (PET), or on the basis of a polyamide, in particular polyamide 6 (PA 6) or polyamide 66 (PA 66), as fibrous pile material. The melting points of PET, PA 6 and PA 66 are about 250, 220 and 255° C., respectively. As support use is often made of fleeces or fabrics based on PET or polypropylene (PP, melting point about 180° C.). In the case of a PET support in combination with said fibres the polymer in the hot-melt adhesive composition will, on the basis of the preferences described above, preferably have a melting point of lower than about 200° C., in the case of a PP support preferably lower than 160° C.

To improve the dimensional and thermal stability of a textile product at a temperature higher than room temperature, such as for instance during a cleaning process, the polymer in the hot-melt adhesive composition preferably has a melting point of higher than 50, more preferably higher than 70, and even more preferably higher than 90° C.

The polymer in the hot-melt adhesive composition according to the invention therefore preferably has a melting point of between 50 and 200° C., more preferably between 70 and 180° C., and most preferably between 90 and 160° C.

The polymer in the hot-melt adhesive composition according to the invention can be prepared by polymerization of suitable monomers using several processes known to one skilled in the art. Suitable processes are described inter alia in the above-mentioned books ‘Nylon Plastics Handbook’ and ‘Encyclopaedia of polymer science and engineering’, Volume 12, and the references cited therein. The type and amount of functional end groups, and thus the molecular mass of the polymer, can be controlled on the basis of the types and amounts of comonomers. A polymer with carboxylic acid groups as functional end groups can for instance be obtained by using an excess of a dicarboxylic acid monomer. Non-reactive groups are obtained by for instance adding an amount of a monocarboxylic acid to the mixture of monomers to be polymerized. One skilled in the art can in a simple manner calculate or determine by means of experiments what is a suitable amount of comonomer for obtaining a polymer with desired molecular mass and functional end groups.

In another process for the preparation of the polymer in the hot-melt adhesive composition a polymer of a higher molecular mass is decomposed in a controlled way to obtain a polymer of lower molecular mass with functional end groups, by reaction of the polymer with a chain terminator. A polymer of higher molecular mass is here understood to be a polymer with a molecular mass of greater than 5000 g/mol, preferably greater than 10,000 g/mol. A chain terminator is here understood to be a compound with at least one reactive group, which is capable of reaction with for instance an amide group in a polyamide. Such a process is described inter alia for polyamides by D. Lehmann et al. in Kautschuk Gummi Kunststoffe 49(10), p. 658-665 (1996), and by E. Taeger et al. in Chemiefasern/Textilindustrie, 43, p. 526-531 (1993). Examples of a suitable chain terminator are aliphatic, cycloaliphatic or aromatic compounds with 1-24 C atoms and optionally one or more heteroatoms, which compounds contain at least one group that is reactive with a polyamide or polyester, for instance a carboxylic acid group, a carboxylic anhydride group, a hydroxy group or an amine group. For the decomposition of a polyamide preferably a dicarboxylic acid or a dicarboxylic anhydride is chosen as chain terminator. This has the advantage that a high-molecular polyamide can in a controlled way be converted to a polyamide of lower molecular mass with terminal carboxylic acid groups by means of a fast reaction in the melt phase. The polymer of higher molecular mass may have been prepared for this purpose, but is preferably a production residue, or recovered from production residues or waste containing this polymer, or recovered from a post-consumer product containing this polymer of higher molecular mass. Examples of the last-mentioned case are polyamide (PA 6 or PA 66) fibre material recovered from, for instance, post-consumer carpets. Suitable processes for the recovery of a polymer from post-consumer products are for instance described in ‘Die Wiederverwertung von Kunststoffen’, J. Brandrup (Ed.), Hanser Verlag, Munich 1995 (ISBN 3-446-17412-5), p. 181-280, p. 730-745. More preferably, the polymer in the hot-melt adhesive composition is prepared by reaction of a dicarboxylic acid or a dicarboxylic anhydride as chain terminator with a polyamide 6 of higher molecular mass, which polyamide 6 has been recovered from post-consumer carpets. This process has the advantage that material reuse can take place in a closed cycle.

In a preferred embodiment of the invention the hot-melt adhesive composition also contains a chain extender and/or crosslinking agent. This has the advantage that the hot-melt adhesive composition, after having been applied to for instance a tufted support, in melted condition initially exhibits a low viscosity and can suitably penetrate the fibre bundle, while afterwards, as a result of chain extension and/or crosslinking, the viscosity increases, so that the textile product formed exhibits better mechanical properties. As chain extender and/or crosslinking agent all known compounds can be chosen that contain at least two groups that can react with the reactive groups of the polymer in the hot-melt adhesive composition. Preferably that reaction takes place only, or at any rate in an appreciable manner, when the hot-melt adhesive composition is heated to above the melting point of the polymer. Examples of suitable chain extenders and/or crosslinking agents are bi- or polyfunctional isocyanates, blocked isocyanates, epoxides, oxazines, oxazolines, lactams, carbonyl lactams, acyl lactams, bisacyl lactams, or combinations of such compounds. In the case of a polymer with mainly hydroxy or amine groups as reactive groups, preferably a compound chosen from the group of blocked isocyanates, acyl lactams and carbamoyl lactams, more preferably a carbonyl bislactam, in particular carbonyl biscaprolactam, is used as chain extender and/or crosslinking agent, as for instance described in patent publication WO-A-9847940. If the polymer in the hot-melt adhesive composition mainly has carboxylic acid groups, use is preferably made of a chain extender and/or crosslinking agent with epoxide, hydroxyalkylamide, oxazine, or oxazoline groups. More preferably a chain extender and/or crosslinking agent with epoxide groups and hydroxyalkylamide groups is used. Suitable examples of chain extenders and/or crosslinking agents with epoxide groups are polyethers on the basis of bisphenol-A-diglycidyl ether, and di- and triglycidyl ethers of polycarboxylic acids and isocyanuric acid. As chain extender and/or crosslinking agent with epoxide groups use is preferably made of triglycidyl isocyanurate (known as TGIC, Araldite® PT810, ex Ciba), diglycidyl terephthalate and/or triglycidyl trimellitate (a mixture of this is commercial under the name of Araldite® PT910, ex Ciba), and glycidyl-functional polyethers on the basis of bisphenol-A-diglycidyl ether such as Araidite® GT7004 (Ciba), or Epon®828 and 1001 (ex Shell Chemical). Suitable examples of chain extenders and/or crosslinking agents containing hydroxylalkylamide groups are Primid® XL552 and QM1260 (ex EMS) and condensation polymers that contain branched β-substituted β-hydroxyalkylamide groups and have a weight-average molar mass >800 g/mol as described in WO-A-99/16810. Preferably the last-mentioned condensation polymers are used as chain extenders and/or crosslinking agents with hydroxyalkylamide groups.

If the polymer contains various types of reactive groups, preferably a combination of different chain extenders and/or crosslinking agents is used. If desired, other compounds may also be added to accelerate the reactions. The amount of chain extender and/or crosslinking agent incorporated in the hot-melt adhesive composition depends among other things on the type and number of reactive groups in the polymer and the desired increase in the molecular mass, and generally amounts to about 0.1-15 mass % relative to polymer. Preferably the hot-melt adhesive composition according to the invention also contains a compound that accelerates the reaction between reactive groups and chain extender and/or crosslinking agent. Suitable examples of a compound that can accelerate the reaction between the reactive carboxylic acid groups of the polymer according to the invention and the epoxide groups of a chain extender and/or crosslinking agent are ethyl triphenyl phosphonium bromide (TRAB) and tetrabutyl ammonium bromide.

In addition, the hot-melt adhesive composition according to the invention may contain one or more of the customary additives, including stabilizers, colourants, fillers, etc. If the hot-melt adhesive composition has the form of a paste or a dispersion or emulsion, the composition moreover contains water and if necessary an organic solvent, and optionally dispersion aids, viscosity controlling agents, etc. The hot-melt adhesive composition according to the invention can be prepared using various known processes. Depending on the desired form of the hot-melt adhesive composition, the various constituent components are mixed in solid condition to obtain a powder, or they are formed into an aqueous dispersion or paste in the presence of water.

In a special embodiment of the invention the hot-melt adhesive composition comprises an aqueous dispersion of the polymer, with the carboxylic acid end groups of the polymer, preferably a polyamide, preferably having been partly neutralized by reaction with for instance a lye. This has the advantage that the polymer itself acts as dispersion aid, so that less auxiliary materials are needed.

The invention also relates to the use of the hot-melt adhesive composition according to the invention as adhesive for the preparation of a textile product, characterized in that the melting point of the polymer in the hot-melt adhesive composition is lower than the melting points of the components to be bonded in the textile product. Preferably at least one of the components to be bonded largely consists of a polymer chosen from the same group of polyamides as the polymer in the hot-melt adhesive composition. The advantage of the use of the hot-melt adhesive composition according to the invention as adhesive is that an excellent bond between the components is formed already when a relatively small amount of adhesive is used.

The invention also relates to a process for the preparation of a textile product containing a support into which a fibrous pile material has been inserted, so that a pile projects at a front side of the support, and a loop is formed at a back, in particular a tufted carpet, at least comprising the following steps

(a) application of a hot-melt adhesive composition according to the invention to the back of the support, the hot-melt adhesive composition having a melting point that is lower than the melting points of the pile and support, and with at least the hot-melt adhesive composition and the pile material comprising a polymer chosen from the group of polyamides; and

(b) then heating to a temperature higher than the melting point of the polymer in the hot-melt adhesive composition and lower than the melting points of the pile and support and subsequently cooling.

In particular the invention relates to a process for the preparation of a textile product, in particular a tufted carpet, in which the hot-melt adhesive composition is applied in the form of a powder. The advantage of this process is that it can be carried out in a simple manner, while energy consumption remains relatively low. The powder can be applied in different ways, for instance by mechanical distribution. In a special embodiment of the process according to the invention the hot-melt adhesive composition in powder form is applied using the same technique as used for applying a powder paint composition to a substrate, as described by Misev in Powder Coatings, Chemistry and Technology (1991, John Wiley). More preferably the hot-melt adhesive composition is applied analogously to a powder paint composition using the Electro-Magnetic Brush technique, as described in patent specification EP-B-0792325. This has the advantage that a thin layer of adhesive can be applied in an accurate and reproducible manner.

In another special embodiment of the process according to the invention the hot-melt adhesive composition is applied in the form of an aqueous suspension or paste, the water being at least in part evaporated before the temperature is raised to above the melting point of the polymer in the hot-melt adhesive composition. The advantage of this process is that it can be carried out using existing equipment, optionally with minor modifications.

It has been found that, after melting, the hot-melt adhesive composition flows substantially to and into the loops of the pile material at the back of the support, in particular if the support consists substantially of a polymer not chosen from the same group; for instance a polyamide polymer in the hot-melt adhesive composition and the pile material and a polyester or polypropylene as the support. This has as an advantage that the adhesive is used efficiently, that is, that it is present in particular at those places where it is to perform its bonding function. Another advantage is that the carpet has a lower weight and will be easier to roll up, so that transport costs, too, will be reduced. Another advantage is that the support is not fully covered with the adhesive, and can be contacted directly with any backing material, or with a second adhesive that improves the bond between the support and the backing material. As backing material use is often made of a polyolefin, for instance a polyethylene.

In a special embodiment of the process according to the invention a polyethylene backing material in powder form is applied to the back of the support, after the hot-melt adhesive composition has been applied and melted, following which the temperature is raised to the point where the polyethylene melts and is distributed over the surface. The advantage of this process is that the backing material is bonded directly to the support, in particular when polypropylene is used as support.

In another special embodiment of the process according to the invention a polyethylene backing material in powder form is applied to the back of the support, before the hot-melt adhesive composition applied has melted, following which the temperature is raised to such a value that both the polyethylene and the hot-melt adhesive composition melt. In this case, too, the backing material is bonded to the support and the pile material exhibits a good withdrawal force and pilling resistance.

The invention also relates to a textile product, in particular a tufted carpet, obtainable by the process according to the invention. Advantages compared with known textile products are good properties such as withdrawal force and pilling resistance, an attractive cost price and good possibilities for reprocessing of production waste and post-consumer products, for instance carpet.

The invention also relates to the use of a textile product, in particular a tufted carpet, obtainable by the process according to the invention, as floor or wall covering.

The invention will now be further elucidated on the basis of the following examples and comparative experiments.

### EXAMPLES

### Preparation of Polymer

### Example I

A reaction vessel capable of being pressurized, provided with stirring gear (autoclave), is fed with a mixture of ε-caprolactam (6), α,ω-aminoundecanoic acid (11) and nylon 6.6-salt (6.6; reaction product of adipic acid and hexamethylene diamine), the molar ratio of 6/11/6.6 being about 50/30/20. In addition, such an amount of adipic acid was added that the polymer to be formed would theoretically have a molecular mass of 3512 g/mol. A nitrogen atmosphere was subsequently applied to the reaction vessel, which was then closed, after which the mixture was heated; with stirring, in three steps to 260° C. After 11 hours of reaction at this temperature the polymer was removed from the reaction vessel, reduced in size, washed with cold water and then dried. Finally, the polymer was heated at 200° C. and atmospheric pressure for 16 hours in an inert atmosphere. By means of titration the content of carboxylic acid end groups in the polymer was determined to be 683 mmol/kg, which together with an amine end groups content of 11 mmol/kg corresponds to a molecular mass of 2882 g/mol. Using a DSC apparatus a melting point of about 119° C. was measured (peak melting temperature, scanning rate 10° C./min).

### Example II

Analogously to the process in Example I a polymer was prepared that also contains 2.2 mol % bis(hexamethylene)triamine as comonomer. This polymer has a theoretical molecular mass of 2700 g/mol, and a degree of branching of 2,5. The content of carboxylic acid end groups in the polymer was found to be 607 mmol/kg, which together with a content of amine end groups of 12 mmol/kg corresponds to a molecular mass of 4040 g/mol. Using a DSC apparatus a melting point of about 117° C. was measured.

### Comparative Experiment A

Analogously to the process in Example I a polymer was prepared from caprolactam and α,ω-aminoundecanoic acid in a molar ratio of about 75/25. The number average molecular mass of this polymer was determined to be 15,400 g/mol (theoretically 13,120 g/mol), while a melting point of about 182° C. was measured.

### Preparation of Hot-Melt Adhesive Composition

Hot-melt adhesive compositions, given in Table 1, were prepared by mixing the various components using a twin-screw extruder. In Table 1, PT910 stands for Araldite® PT910, a mixture of di- and trifunctional epoxide (Ciba) that serves as crosslinking agent for the polymer with carboxylic acid end groups. TRAB is a phosphorus compound (triphenylethyl phosphonium bromide), and serves as a catalyst for the reaction between the epoxide and carboxylic acid groups. During mixing the temperature was kept between about 110 and 140° C. to prevent a premature reaction between polymer and crosslinking agent. The temperature preferably lies just below the melting point of the polymer.

### Application of Hot-melt Adhesive Composition

The various polymers and hot-Melt adhesive compositions were cryogenically ground to obtain a powder with a particle size smaller than about 1 mm.

### Examples III-VII

The resulting power was then manually applied to the back of a textile product measuring about 10 to 10 cm by sprinkling the powder uniformly over the surface. This carpet sample consisted of a polyester support into which a polyamide 6 pile material had been inserted by means of tufting (so without adhesive). The amount of hot-melt adhesive composition applied was about 300 g/m². The sample was subsequently heated for about 10 minutes in an oven at 150 or 180° C. It was visually observed that the hot-melt adhesive composition melted and was incorporated in the carpet sample. The compositions are given in Table 1.

### Examples VIII-XVI

The powdery adhesive was applied to the back of a carpet sample without adhesive by means of a process that is also used for (electrostatic) application of a powder paint composition to a substrate. Using this process it proved to be possible to apply a homogenous, thin layer of powder, in Example XV even only 83 g/m², see Table 2. After powder application the carpet sample was heated for 10 minutes in an oven at 180° C.

### Determination of Withdrawal Force

To test the bond between pile material and support after application of the hot-melt adhesive composition, a test method was used that is analogous to the method according to ISO 4919 (1978). This involved horizontal clamping of the carpet sample using a metal plate with a recess measuring about 4 by 8 cm. A hook was then attached to a loop of a pile, which hook was connected to a force transducer that was subsequently moved, at a constant speed of 10 mm/min, virtually perpendicularly away from the carpet sample. The values for the withdrawal force given in Tables 1 and 2 are the averages of at least 10 measurements. These results prove that crosslinking of the polymer in a hot-melt adhesive composition has a positive effect on the bond obtained between pile and support. It also appears that even at small amounts of hot-melt adhesive composition according to the invention a good bond is still observed; at somewhat larger amounts a minimum value of 30 N, a value used in industry for carpets subjected to very intensive use, is amply met.

The pilling resistance of the carpet samples was tested by applying a strip of Velcro at the front of the pile material and pulling it off in a rapid movement. Samples with a good withdrawal force also appear to have a low pilling tendency, which implies that the various fibres in a fibre bundle are also bonded together by the hot-melt adhesive composition.

### Comparative Experiment B

In the same way as in Examples III-VII powdery polymer according to Comparative experiment A was applied to a carpet sample. After the temperature treatment in the oven, the polymer was still found to be clearly present at the back, and not (at 150° C.) or not entirely (at 180° C.) to have melted. When the withdrawal force was determined, meaningful measurements proved hardly possible, the pile material was found to be hardly bonded to the support.

TABLE 1

| | hot-melt adhesive composition | | | | |
|---|---|---|---|---|---|
| | | crosslinking | | | |
| | | agent | catalyst | F(150) | F(180) |
| | Polymer | (mass %) | (mass %) | (N) | (N) |
| Example III | Ex. I | (0) | (0) | 36 ± 15 | 34 ± 11 |
| Example IV | Ex. I | PT910 (9) | TRAB (0.1) | 25 ± 7 | 38 ± 11 |
| Example V | Ex. I | PT910 (9) | TRAB (0.2) | 25 ± 10 | 52 ± 13 |
| Example VI | Ex. II | (0) | (0) | 41 ± 14 | 44 ± 18 |
| Example VII | Ex. II | PT910 (9) | TRAB (0.1) | 34 ± 4 | 58 ± 11 |

F(YY): average withdrawal force (and standard deviation) measured on carpet sample with 300 g/m² hot-melt adhesive composition, applied at YY° C., 10 minutes.

TABLE 2

| | Hot-melt adhesive composition | | | | |
|---|---|---|---|---|---|
| | | crosslinking | | amount | |
| | | agent | catalyst | applied | F(180) |
| | Polymer | (mass %) | (mass %) | g/m²) | (N) |
| Example VIII | Ex. I | PT910 (9) | TRAB (0.1) | 102 | 17 ± 3 |
| Example IX | Ex. I | PT910 (9) | TRAB (0.1) | 130 | 26 ± 6 |
| Example X | Ex. I | PT910 (9) | TRAB (0.2) | 108 | 20 ± 6 |
| Example XI | Ex. I | PT910 (9) | TRAB (0.2) | 147 | 20 ± 4 |
| Example XII | Ex. II | PT910 (9) | TRAB (0.1) | 120 | 23 ± 4 |
| Example XIII | Ex. II | PT910 (9) | TRAB (0.1) | 160 | 34 ± 8 |
| Example XIV | Ex. II | PT910 (9) | TRAB (0.1) | 240 | 42 ± 6 |
| Example XV | Ex. II | PT910 (9) | TRAB (0.3) | 83 | 17 ± 5 |
| Example XVI | Ex. II | PT910 (9) | TRAB (0.3) | 120 | 19 ± 6 |

1. Hot-melt adhesive composition for use in a textile product, in particular a tufted carpet, containing a polymer chosen from the group of polyamides, characterized in that the polymer has a number-average molecular mass of 500-5000 g/mol and functional end groups.

2. Hot-melt adhesive composition according to claim 1, wherein the polymer has a number average molecular mass of 1000-4000 g/mol.

3. Hot-melt adhesive composition according to either of claims 1-2, wherein the polymer has a melt viscosity of 1-200 Pa.s at 180° C.

4. Hot-melt adhesive composition according to claim 3, wherein the polymer has a melt viscosity of 2-100 Pa.s at 180° C.

5. Hot-melt adhesive composition according to claim 4, wherein the polymer has a melt viscosity of 5-50 Pa.s at 180° C.

6. Hot-melt adhesive composition according to any one of claims 1-5, wherein the polymer has only reactive groups, only non-reactive groups, or a combination of reactive and non-reactive groups as functional end groups.

7. Hot-melt adhesive composition according to claim 6, wherein the polymer has at least two reactive groups.

8. Hot-melt adhesive composition according to any one of claims 1-7, wherein the polymer is branched.

9. Hot-melt adhesive composition according to claim 1-8, wherein the polyamide is substantially composed of ε-caprolactam as monomer.

10. Hot-melt adhesive composition according to any one of claims 1-9, wherein the polymer has a melting point between 50 and 200° C.

11. Hot-melt adhesive composition according to any one of claims 1-10, wherein the hot-melt adhesive composition also contains a chain extender and/or crosslinking agent.

12. Hot-melt adhesive composition according to claim 11, wherein the polymer has carboxylic acid groups as reactive groups, and the chain extender and/or crosslinking agent contains epoxide groups.

13. Hot-melt adhesive composition according to any one of claims 1-12, which hot-melt adhesive composition is in powder form.

14. Hot-melt adhesive composition according to any one of claims 1-12, which hot-melt adhesive composition is an aqueous dispersion, with the carboxylic end groups of the polymer, preferably a polyamide, being partly neutralized.

15. Process for the preparation of a textile product containing a support into which a fibrous pile material has been inserted, such that a pile projects at a front side of the support, and a loop is formed at a back, in particular a tufted carpet, at least comprising the following steps
(a) application of a hot-melt adhesive composition to the back of the support, the hot-melt adhesive composition having a melting point that is lower than the melting points of the pile and support materials, and with at least the hot-melt adhesive composition and the pile material comprising a polymer chosen from the group of polyamides; and;
(b) then heating to a temperature higher than the melting point of the polymer in the hot-melt adhesive composition and lower than the melting points of the pile and support materials and subsequently cooling;
characterized in that a hot-melt adhesive composition according to any one of claims 1-14 is used.

16. Process according to claim 15, in which the hot-melt adhesive composition is applied in the form of a powder.

17. Process according to claim 15, in which the hot-melt adhesive composition is applied in the form of an aqueous suspension or paste and water is at least partly evaporated before step b).

18. Process according to any one of claims 15-17, in which a backing material is applied after step b) by distributing polyethylene in powder form over the back of the support and subsequently melting the polyethylene.

19. Process according to any one of claims 15-17, in which a backing material is applied after step a) by distributing polyethylene in powder form over the back of the support and subsequently melting the polyethylene together with the hot-melt adhesive composition.

20. Textile product, in particular a tufted carpet, obtainable by the process according to any one of claims 15-19.

21. Use of a textile product, in particular a tufted carpet, obtainable by the process according to any one of claims 15-19, as floor or wall covering.
